(19) United States
(12) Patent Application Publication
(10) Pub. No.: US 2016/0250646 A1
(43) Pub. Date: Sep. 1, 2016

(54) TREADED LIFTER BAR

(71) Applicant: TEGA INDUSTRIES LIMITED, Kolkata, West Bengal (IN)

(72) Inventors: Madan Mohan MOHANKA, Kolkata (IN); Some Nath GHOSH, Kolkata (IN)

(73) Assignee: TEGA INDUSTRIES LIMITED, Kolkata, West Bengal (IN)

(21) Appl. No.: 15/029,065

(22) PCT Filed: Oct. 17, 2014
(86) PCT No.: PCT/IN2014/000659

§ 371 Date: Apr. 13, 2016

(30) Foreign Application Priority Data
Oct. 17, 2013 (IN) 420/KOL/2013

(51) Int. Cl. B02C 17/18

(52) U.S. Cl. CPC B02C 17/1825; B02C 2210/02

(57) ABSTRACT

A treaded lifter bar (1) for grinding mill is provided with a plurality of flexible treads (2) positioned over the core rubber matrix forming its main rubber surface. Treads (2) have a zig-zag configuration with higher rubber content in their wear zone to increase the surface area and reduce the wearing lifter bar (1). The treads (2) primarily absorb the impact force (3a) of slurry (4) and dissipate the heat generated due to impact. The slurry (4) is deposited on top of the treads (2) thus protecting the treads (2) from direct contact with the slurry (4) to ensure less wear. The zig-zag configuration of the top wearing treads (2) of the treaded lifter provides increased wear volume.

### FIELD OF THE INVENTION

The present invention in general relates to grinding mills for grinding of minerals in the mining and quarrying industries. More particularly, the present invention relates to a treaded lifter bar that are arranged in polar array which provide cushioning effect to the lifter bar as well as the steel shell of the grinding, mill against the high impact forces that result due to falling of lump of materials/slurry on the lifter bar. The treaded lifter bar is used to protect the steel shell of a grinding mill, the prime equipment used to grind minerals from lump to micron level to liberate metal from their ores.

### BACKGROUND AND PRIOR ART

Grinding mills are used in various industries to process hard, solid materials, such as rock and mineral ores in order to crush, grind or comminute the material into smaller sizes. Typically grinding mills generally comprise a drum shaped shell mounted for rotation about its central axis. The shell is generally horizontally disposed or slightly inclined towards one end. The interior of the shell forms a treatment chamber into which the material to be processed is fed. During rotation of the shell the grinding medium acts on the material to cause the crushing or grinding action. The grinding medium and material to be processed are carried up the side of the shell as a result of the rotation of the shell where after it falls towards the bottom of the shell under the influence of gravity.

The inside surfaces of the mill are typically protected by an arrangement of wear components collectively referred to as a mill liner. The mill liner usually includes lifter bars spaced around the inner circumference of the mill. The lifter bars assist in lifting the charge inside the mill up the side of the shell as the shell′ rotates. Further, the mill liner often includes wear plates which are provided in between each lifter bar.

Over time, the components of the mill liner wear away and require replacement. This necessitates that the mill be stopped for a period of time which causes the cessation of the grinding of material, and may also necessitate the shutting down of other machinery in a plant which works on the material produced by the mill. There is a continued need to provide mill liner components with improved longer service lives to reduce the mill stoppage time. There remains a need for improvements to ease the process of installation and removal of lifters bars into and out of a grinding mill.

WO2010/017589 discloses a lifter (1) for SAG mills that reduces the need for replacement in mills, and enables the use of both its main face and its rear face. Its main face is formed by a steel plate (2), the inner part of the rear face has a steel core (3), and the lower section has a fixing assembly (5) formed from structural steel, all being embodied as a monolithic bar, by means of rubber (4) that joins the steel plate, the steel core and the fixing assembly. The main face with the steel plate has at least one lifting face lug (6). Likewise, the rear face has at least one rear face lug (7). The fixing assembly is formed by two horizontal plates (8) connected by an inverted U-shaped section (9), forming a central cavity (10).

EP 1810 752A1 discloses an inner lining for rotary drum mills (2) which comprises at least one metal section bar (1) suitable for being fixed to the inner surface of a rotary drum (2), wherein the upper portion of the section bar (1) is shaped for forming a head suitable for being press-fitted into a complementary groove made in an elastomeric member (3), so as to fix the latter onto the inner surface of the rotary drum (2), while the lower portion of the section bar is shaped for forming a neck narrower than the head, so that two lips (3a) arranged along the lower edges of the groove of the elastomeric member (3) are comprised between the head of the section bar (1) and the inner surface of the rotary drum (2), wherein the section bar (1) comprises a canal (1a) which is open downwards and is shaped with two opposing ribs (1b) which protrude inwards along the lower edges of the canal (1a); for retaining a fixing member (4) which can be inserted into the canal (1a) from an end of the section bar (1).

CN102847590 discloses a non-uniform permanent magnetic field ultrahigh-molecular-weight polyethylene magnetic lining plate. A detachable lifting bar is arranged on the upper part of a housing. A wear-resistant composite material layer is provided on the shell of the housing. Blocking grooves are provided on sides of the upper ends on two sides of the housing. Two magnetic poles which are a first main magnetic pole and a second main magnetic pole are embedded in the housing. Positions of the first main magnetic pole and the second main magnetic pole contacting the shell are embedded with damping bars. The housing of the lining plate adopts an ultrahigh-molecular-weight polyethylene material. The composite material coating is a fluorocarbon rubber modified material, a tungsten carbide material, a metal ceramic material, a magnetron sputtering material, or a nano-grade material. The ultrahigh-molecular-weight polyethylene housing is lighter than a metal housing, and the detachable lifting bar is arranged between lining plates, such that steel ball uplifting and lining plate abrasion reducing functions can be achieved. Therefore, ball milling machine energy consumption can be reduced, ore milling efficiency can be improved, and magnetic lining plate service life can be prolonged.

WO2010/017589 discloses a method of fabricating a liner component for a grinding mill, the method including the steps of providing a plate of hard material; cutting the plate to form a plurality of inserts, at least some of the inserts including a formation for mechanically engaging with a body of a resilient material; arranging the inserts in a mould, and—adding resilient material to the mould to form a resilient material body around the inserts to thereby form the liner component.

However, none of these documents address the shortcomings of the prior art mentioned above.

All throughout the specification including the claims, the words “mining”, “quarrying”, “mineral”, “ores”, “abrasion resistant”, “wear resistant”, “sections”, “zones”, “impact zone”, “roll-over zone”, “free zone”, “cushioning effect” are to be interpreted in the broadest sense of the respective terms and includes all similar items in the field known by other terms, as may be clear to persons skilled in the art. Restriction/limitation, if any, referred to in the specification, is solely by way of example and understanding of the present invention.

### OBJECTS OF THE INVENTION

The principal object of the present invention is to provide a lifter bar which reduces mill stoppage time thereby reducing the shutting down of other machinery in a plant which works on the material produced by the mill.

Another object of the present invention is to provide a lifter bar which has a long service life.

Yet another object of the present invention is to provide a lifter bar which can be made at a reasonable cost.

A further object of the present invention is to provide a lifter bar which can reduce impact force.

It is yet another object of the present invention to provide a lifter bar which is abrasion resistant.

It is yet another object of the present invention to provide a lifter bar which helps in dissipating heat due to presence of air-gap between the treads.

It is yet another object of the present invention to provide a lifter bar which provides cushioning effect in the impact zone by bending the treads in the direction of slurry pressure and return to its resting position when the pressure is withdrawn.

Yet another object of the present invention is to provide a lifter bar which provides cushioning, effect in the roll over zone as the top of the treads are filled up with slurry in this zone.

Yet another object of the invention is to provide a lifter bar having zig-zag configuration on the surface exposed to the impact of the materials/slurry with high rubber content in their wear zone to increase their surface area and help reducing the wearing of the lifter bar.

How the foregoing objects are achieved will be clear from the following description. In this context it is clarified that the description provided is non-limiting and is only by way of explanation.

### SUMMARY OF THE INVENTION

A treaded lifter bar for grinding mill is provided with a plurality of flexible treads which are positioned over the core rubber matrix which forms the main rubber surface of the lifter bar.

The treads are provided with a zig-zag configuration and higher rubber content in their wear zone to increase their surface area and reduce the wearing of said lifter bar.

The treads are adapted to primarily absorb the impact force of the slurry.

The treads are adapted to dissipate the heat generated due to impact.

The slurry is deposited on top of said treads, thus protecting the treads from direct contact with the slurry to ensure less wear.

The zig-zag configuration of said top wearing treads of the treaded lifter provides increased wear volume.

### BRIEF DESCRIPTION OF THE ACCOMPANYING DRAWINGS

The nature and scope of the present invention will be better understood from the accompanying drawings, which are by way of illustration of a preferred embodiment and not by way of any sort of limitation. In the accompanying drawings:—

FIG. 1 is a view of a lifter bar without tread as existing in the prior art.

FIG. 2a is a view of a treaded lifter bar according to the present invention.

FIG. 2b is a cross-sectional view of the treaded lifter bar of FIG. 2a along the line A-A.

FIG. 3 is a view of the treaded lifter bar of FIG. 2a when without pressure.

FIG. 4 is a view of the treaded lifter bar of FIG. 2a when under pressure of slurry.

FIG. 5 is a view of the treaded lifter bar of FIG. 2a with particles on the tread.

FIG. 6 is a view of the treaded lifter bar of FIG. 2a with slurry on the tread.

FIG. 7 is view of the media action zones in rotating mill.

### DETAILED DESCRIPTION OF THE INVENTION

Having described the main features of the invention above, a more detailed and non-limiting description of a preferred embodiment will be given in the following paragraphs with reference to the accompanying drawings.

In all the figures, like reference numerals represent like features. Further, the shape, size and number of the devices shown are by way of example only and it is within the scope of the present invention to change their shape, size and number without departing from the basic principle of the invention.

Further, when in the following it is referred to “top”, “bottom”; “upward”, “downward”, “above” or “below”, “right hand side”, “left hand side” and similar terms, this is strictly referring to an orientation with reference to the apparatus, where the base of the apparatus is horizontal and is at the bottom portion of the figures. The number of components shown is exemplary and not restrictive and it is within the scope of the invention to vary the shape and size of the apparatus as well as the number of its components, without departing from the principle of the present invention.

All through the specification including the claims, the technical terms and abbreviations are to be interpreted in the broadest sense of the respective terms, and include all similar items in the field known by other terms, as may be clear to persons skilled in art. Restriction or limitation if any referred to in the specification, is solely by way of example and understanding the present invention.

Lifter bars are well known in the prior arts. They are provided within grinding mill shells and serve to provide a better tumbling motion within the shell for better mixing and impact grinding.

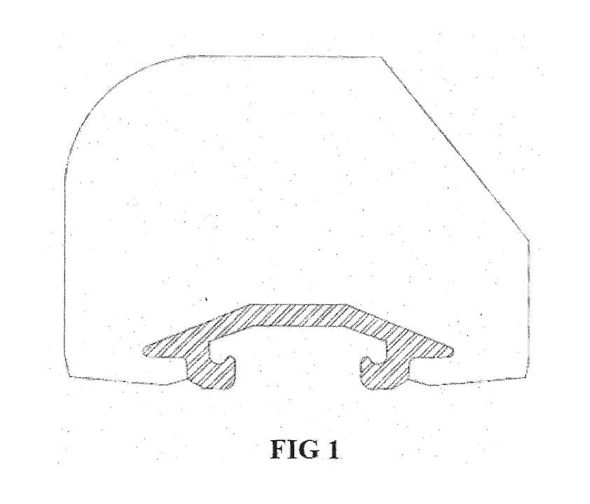

FIG. 1 is a view of a typical lifter bar without tread, as deployed in the prior art.

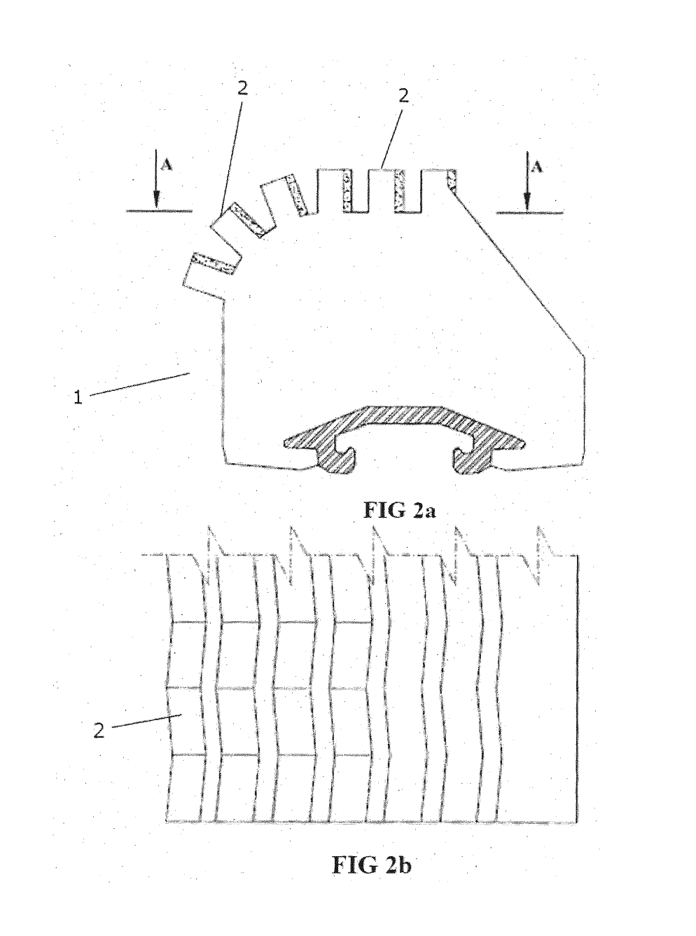

FIG. 2a shows the treaded lifter bar (1) according to the present invention and FIG. 2b shows its cross-sectional view along the line A-A. As shown, a plurality of flexible treads (2) is provided on the top surface of the lifter bar. Therefore, the height of the conventional lifter bar is increased in the form of the treads (2) in the present invention. At the impact zone, the treaded lifter primarily absorbs the impact load thus preventing the effect of the impact to be transferred to the core rubber matrix. This increases the life of the lifter bar which in turn reduces the operation time lost in replacing worn out conventional lifter bar.

At the toe of the charge, every lifter encounters the highest media impact. Under each media impact the lifter bar would go under some shape deformation. This deformation would be normalized upon withdrawal of the impact load that is when the lifter would enter the charge roll over zone. For each on and off impact cycle, some heat development takes place at the core matrix due to hysteresis and this heat cannot be dissipated completely. In fact this un-dissipated heat in the core of the rubber matrix starts deteriorating the rubber properties in the form of edging for a solid lifter bar. In case of the treaded lifter bar, the individual tread absorbs a substantial part of the impact load by undergoing lesser deflection. Due to the presence of the air gap between the tread any heat that is built up due to cyclic loading gets eventually dissipated keeping the core matrix undisturbed. This is one of the major reasons for achieving higher wear life in the treaded lifter bar.

The lifter bar according to the present invention, as best shown in FIG. 2b, is provided with a zig-zag configuration with higher rubber content in their wear zone. The tread has a unique shape as shown in FIGS. 2a and 2b. The zig-zag configuration of the top wearing treads (2) of the treaded lifter provides increased wear volume compared to a solid lifter.

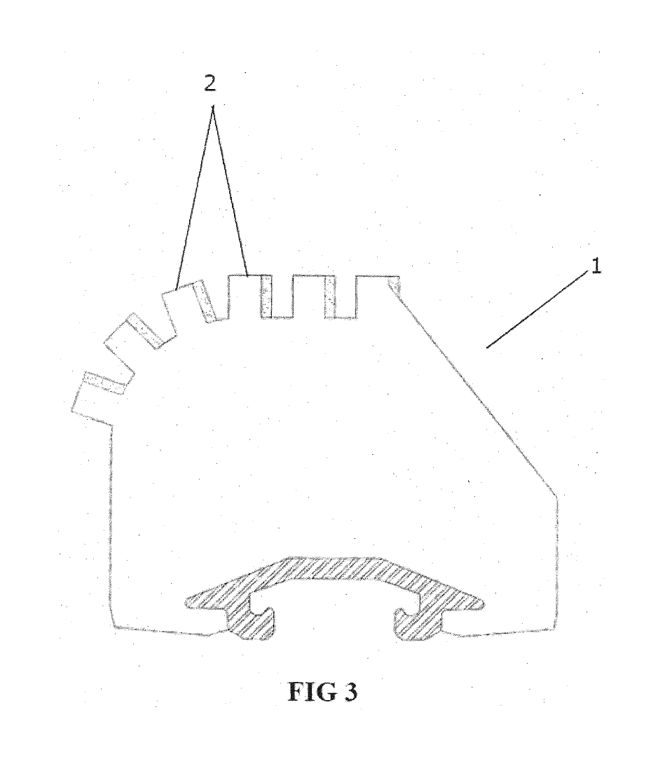

FIG. 3 depicts the treaded lifters in resting condition as present in the free zone (5) of grinding mill.

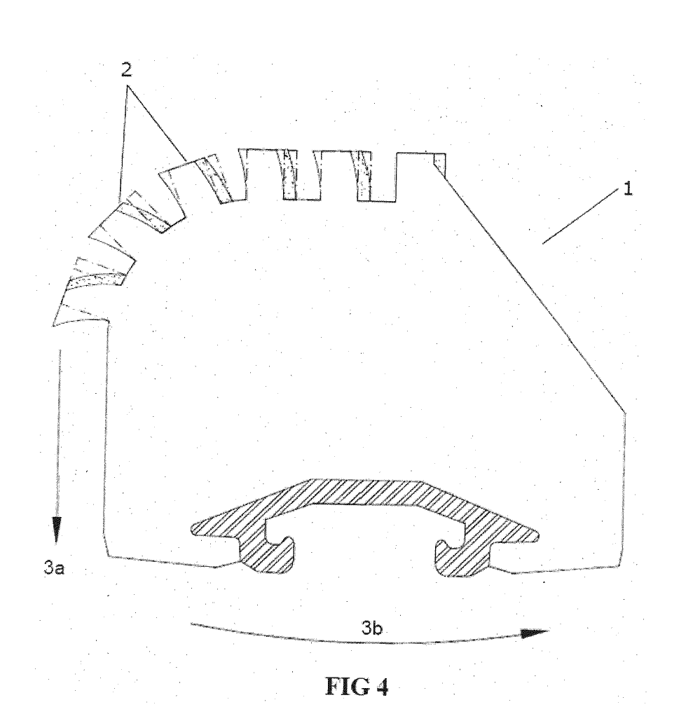

FIG. 4 shows the treaded lifter of FIG. 2a when it is under pressure. During the operation of the grinding mill pressure of the slurry acts in the direction (3a) as shown in this figure. This pressure (3a) causes the tread (2) to bend. The lifter bar moves in the direction (3b) as shown in the figure. The tread comes back to its original position when the pressure is withdrawn. This action provides a cushioning effect, due to which less wear of the treaded lifter takes place.

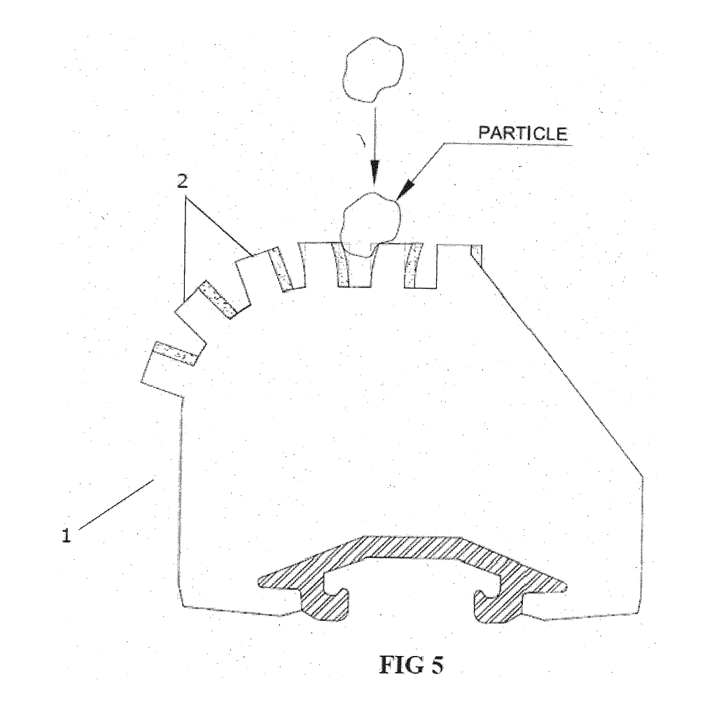

As shown in FIG. 5, during, impact of any, particle, the tread (2) bends on either side and comes back to its original position when the impact is withdrawn.

Thus, the action of the tread as shown in both FIGS. 4 and 5 provides a cushioning effect and causes less wear of the lifter bar and the lining of the grinding mill shells.

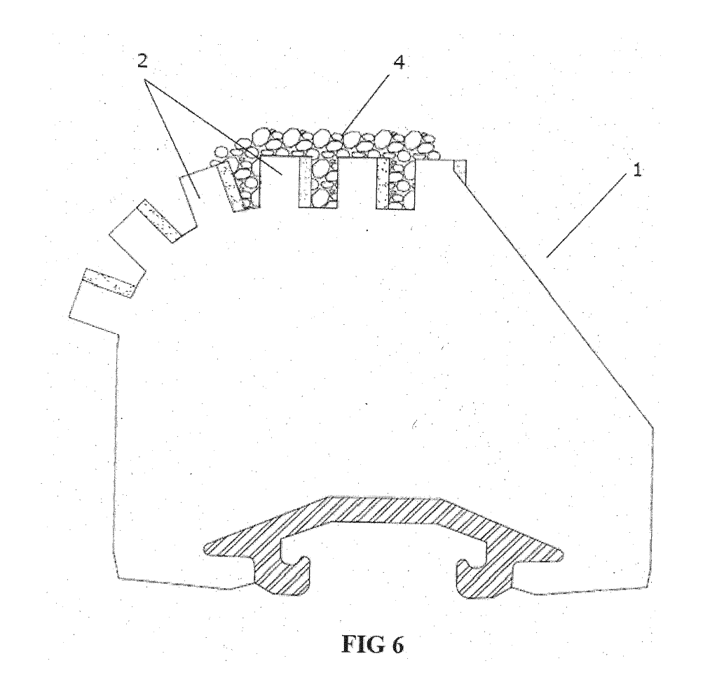

Referring to FIG. 6 during operation, materials in the form of slurry (4) are deposited on top of and in between the treads (2) of the treaded lifter bar mainly during its position in the roll over zone (7). This protects the treads from direct contact with the slurry. So, slurry provides material on material roll over which also ensures that less wear takes place.

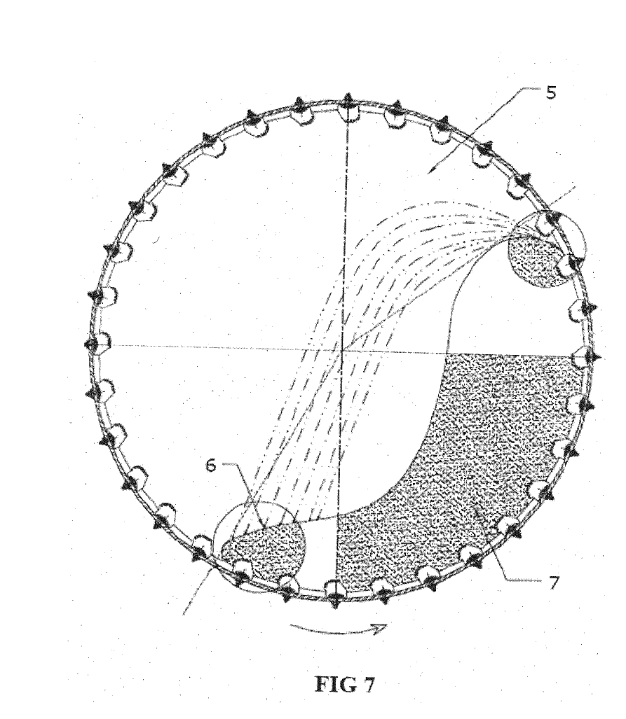

As shown in FIG. 7 the grinding mill in operating condition can be divided into three media action zones—free zone (5), impact zone (6) and roll over zone (7). The lifter bar in the impact zone is subjected to maximum impact during which the treads of the lifter bar align its formation in order to absorb the maximum impact and thus prevent the entire impact-effect to be transmitted to the core matrix zone of the lifter bar. The grinding mill rotates in the direction shown in this figure, the lifter bar moves from the impact zone to the roll over zone. In the roll over zone the gaps between the treads get filled up with ground or partially ground rock slurry. Hence, chipping or abrasion loss of the lifter top due to the charge rolling over becomes lesser as the media motion becomes predominately rolling over the ground material and lesser on the discontinued rubber surface.

The present invention has been described with reference to some drawings and a preferred embodiment purely for the sake of understanding and not by way of any limitation and the present invention includes all legitimate developments within the scope of what has been described herein before and claimed in the appended claims.

1. A treaded lifter bar for grinding mill, the treaded lifter bar comprising:
a plurality of flexible treads positioned over the core rubber matrix which forms the main rubber surface of the lifter bar; and
wherein said treads are provided with zig-zag configuration with higher rubber content in their wear zone to increase the surface area and reduce the wearing of said lifter bar.

2. The treaded lifter bar as claimed in claim 1, wherein said treads are adapted to primarily absorb the impact force of the slurry.

3. The treaded lifter bar as claimed in claim 1, wherein said treads are adapted to dissipate the heat generated due to impact.

4. The treaded lifter bar as claimed in claim 1 and 2, wherein said slurry is deposited on top of and in between the said treads, thus protecting the treads from direct contact with the slurry in the roll over zone to ensure less wear.

5. The treaded lifter bar as claimed in claim 1, wherein said zig-zag configuration of said top of the wearing treads of the treaded lifter provides increased wear volume.
